(19) United States
(12) Patent Application Publication
(10) Pub. No.: US 2016/0100914 A1
(43) Pub. Date: Apr. 14, 2016

(54) Dental repositioning device

(71) Applicants: Darren Buddemeyer, Frontenac, MO (US); Hartwing Ahnfeldt, Siegen (DE); Matthias Hahn, Iserlohn (DE)

(72) Inventors: Darren Buddemeyer, Frontenac, MO (US); Hartwing Ahnfeldt, Siegen (DE); Matthias Hahn, Iserlohn (DE)

(21) Appl. No.: 14/756,633

(22) Filed: Sep. 28, 2015

Related U.S. Application Data
(60) Provisional application No. 62/122,105, filed on Oct. 10, 2014.

(51) Int. Cl. A61C 7/10; A61C 7/02; A61C 7/28

(52) U.S. Cl. CPC A61C 7/10; A61C 7/282; A61C 7/02

(57) ABSTRACT

A dental repositioning device is disclosed which comprises a support plate having a first rod embedded therein and a second rod embedded therein, a first anterior mechanism having a top opening for receiving a set screw and a rear opening, a second anterior mechanism having a top opening for receiving a set screw and a rear opening, a first rod connected between the first anterior mechanism and a first rear mechanism and a spring inserted over the first rod between the first anterior mechanism and the first rear mechanism, a second rod connected between the second anterior mechanism and a second rear mechanism and a spring inserted over the second rod between the second anterior mechanism and the second rear mechanism, a first Z-clip for insertion into the first rear mechanism and a first buccal tube, and a second Z-clip for insertion into the second rear mechanism and a second buccal tube.

### CROSS REFERENCE TO RELATED APPLICATION

This non-provisional patent application claims priority to the provisional patent application having Ser. No. 62/122,105, filed on Oct. 10, 2014.

### FIELD OF THE DISCLOSURE

This disclosure generally relates to orthodontic devices for assisting in orthodontic treatments or procedures, and more particularly to a dental repositioning device for repositioning a tooth for use in orthodontic correction treatments or procedures.

### BACKGROUND

Orthodontists treat patients by controlling the movement and displacement of teeth or the jaws in a mouth by use of various orthodontic devices and procedures. Movement or rotation of a tooth within the mouth may be accomplished through the use of external forces applied to the tooth. To ensure that the moved or treated tooth remains in a desired location in the jaw bone, an external force is applied to the tooth for an extended period of time.

Once the tooth has reached a desired position or orientation, the force may be removed. Some examples of devices used to apply the necessary force to the tooth are braces, brackets, buccal tubes, wires, clamps, or rubber bands.

One known orthodontic device that has been used to correct the misalignment of teeth is an intra-oral device. The intra-oral device may include various components such as telescoping mechanisms, pins, rods, Herbst appliances, elastic materials, and chains. These devices can be bulky, impede tongue mobility, are uncomfortable to wear, and interfere with good oral hygiene. The intra-oral device are typically positioned on the cuspids, bicuspids, or molars and away from a patient's anterior teeth. In view of this, the intra-oral device is hidden in the mouth of the patient. However, one problem associated with the use of the intra-oral device is that the device may break during use. If the device breaks, then the patient must return to the orthodontist to have the component or components replaced to continue the procedure or treatment. Further, during breakage of one or more of the components, damage or injury to the oral cavity may occur. For example, a wire may become dislodged and be inserted or impaled into the cheek.

Various other devices have been proposed and used to attempt to correct the misalignment of teeth. For example, a force-applying device such as a headgear device that includes strapping that extends around the head of the patient and connects to various brackets attached to the teeth has been used. Since headgear is worn outside the mouth, it has been found unacceptable to some patients due to the physical visual obstruction and embarrassment of wearing it. Further, due to the embarrassment, some patients fail to wear the headgear device on a consistent basis. This can impact the progress of treatment and the length of time of treatment. If the time of treatment is extended, this could increase the cost of the treatment.

The present disclosure is designed to obviate and overcome many of the disadvantages and shortcomings experienced with prior orthodontic devices. Moreover, the present disclosure is related to a dental repositioning device that can reposition teeth within a mouth of a patient to correct a misaligned condition. Further, it would be advantageous to have a dental repositioning device that can be easily adjusted or incrementally adjusted to correct a misaligned condition.

### SUMMARY

The present disclosure is a dental repositioning device which comprises a support plate having a first rod embedded therein and a second rod embedded therein, a first anterior mechanism having a top opening for receiving a set screw and a rear opening, a second anterior mechanism having a top opening for receiving a set screw and a rear opening, a first rod connected between the first anterior mechanism and a first rear mechanism and a spring inserted over the first rod between the first anterior mechanism and the first rear mechanism, a second rod connected between the second anterior mechanism and a second rear mechanism and a spring inserted over the second rod between the second anterior mechanism and the second rear mechanism, a first Z-clip for insertion into the first rear mechanism and a first buccal tube, and a second Z-clip for insertion into the second rear mechanism and a second buccal tube.

In another form of the present disclosure, a dental repositioning device comprises a support plate having a rod embedded therein with the rod having a pair of ends extending out of the support plate, a first anterior mechanism having a top opening for receiving a set screw, a front opening for receiving one of the pair of rod ends extending out of the support plate, and a rear opening, a second anterior mechanism having a top opening for receiving a set screw, a front opening for receiving the other one of the pair of rod ends extending out of the support plate, and a rear opening, a first rod inserted into the rear opening of the first anterior mechanism and extending between the first anterior mechanism and a first rear mechanism and a spring inserted over the first rod between the first anterior mechanism and the first rear mechanism, a second rod inserted into the rear opening of the second anterior mechanism and extending between the second anterior mechanism and a second rear mechanism and a spring inserted over the second rod between the second anterior mechanism and the second rear mechanism, a first Z-clip for insertion into the first rear mechanism and a first buccal tube, and a second Z-clip for insertion into the second rear mechanism and a second buccal tube.

In yet another form of the present disclosure, a dental repositioning device is disclosed which comprises a support plate having a first rod embedded therein and extending out of the support plate adapted for placement on a tooth and a second rod embedded therein and extending out of the support plate adapted for placement on another tooth, a first anterior mechanism having a top opening for receiving a set screw and a rear opening, a second anterior mechanism having a top opening for receiving a set screw and a rear opening, a first rod embedded in the support plate and extending between the first anterior mechanism and a first rear mechanism and a spring inserted over the first rod between the first anterior mechanism and the first rear mechanism, a second rod embedded in the support plate and between the second anterior mechanism and a second rear mechanism and a spring inserted over the second rod between the second anterior mechanism and the second rear mechanism, a first Z-clip for insertion into the first rear mechanism and a first buccal tube, and a second Z-clip for insertion into the second rear mechanism and a second buccal tube.

In light of the foregoing comments, it will be recognized that the present disclosure provides a dental repositioning device for use in orthodontic procedures to correct positioning of teeth within a mouth of a patient.

The present disclosure provides a dental repositioning device that can be easily employed with highly reliable results to be placed on teeth to exert a force on teeth to reposition teeth within a mouth of a patient.

The present disclosure also provides a dental repositioning device that may be used to align teeth in incremental treatments.

The present disclosure further provides a dental repositioning device that may be temporarily placed on teeth to reposition teeth within a mouth of a patient.

The present disclosure provides a dental repositioning device that requires only a single tool for repositioning the device on teeth.

The present disclosure provides a dental repositioning device that is comfortable to wear and simple to manage.

The present disclosure is also directed to a dental repositioning device that can be used to mesialize a molar.

The present disclosure provides a dental repositioning device that is placed inside the mouth, is not bulky, and has few moving parts.

The present disclosure is also directed to a dental repositioning device that has a wrench device for rotating a set screw for biasing the device.

The present disclosure provides a dental repositioning device that has an elastic nickel titanium spring that can maintain a consistent 200 grams of force to assist in repositioning a tooth in the mouth of a patient.

These and other advantages of the present disclosure will become apparent to those skilled in the art after considering the following detailed specification in conjunction with the accompanying drawings.

### BRIEF DESCRIPTION OF THE DRAWINGS

FIG. 1 is a top perspective view of a dental repositioning device constructed according to the present disclosure being positioned on the inside of a mouth of a patient;

FIG. 2 is a perspective view of a spring used in connection with the dental repositioning device constructed according to the present disclosure;

FIG. 3 is a perspective view of a Z-clip used in connection with the dental repositioning device constructed according to the present disclosure;

FIG. 4 is a perspective view of a set screw used in connection with the dental repositioning device constructed according to the present disclosure;

FIG. 5 is a a perspective view of a type of wrench device used in connection with the dental repositioning device constructed according to the present disclosure;

FIG. S is a partial side view of the dental repositioning device constructed according to the present disclosure being used to mesialize a molar;

FIG. 7 is a perspective view of the dental repositioning device constructed according to the present disclosure being adjusted by use of a hand wrench;

FIG. 8 is a sectional view of one of the first or second anterior mechanisms, or the first or second rear mechanisms, showing how a rod locates therein and the spring threadedly engages within the mechanism to hold it in position when inserted into any of the said mechanisms; and

FIG. 9 shows how the mechanism has threading slots that allows for locating of the spring therein, surrounding the rod, to affix the spring into position for either providing tension or compression for pushing or pulling of its attached molar.

### DETAILED DESCRIPTION OF PREFERRED EMBODIMENTS

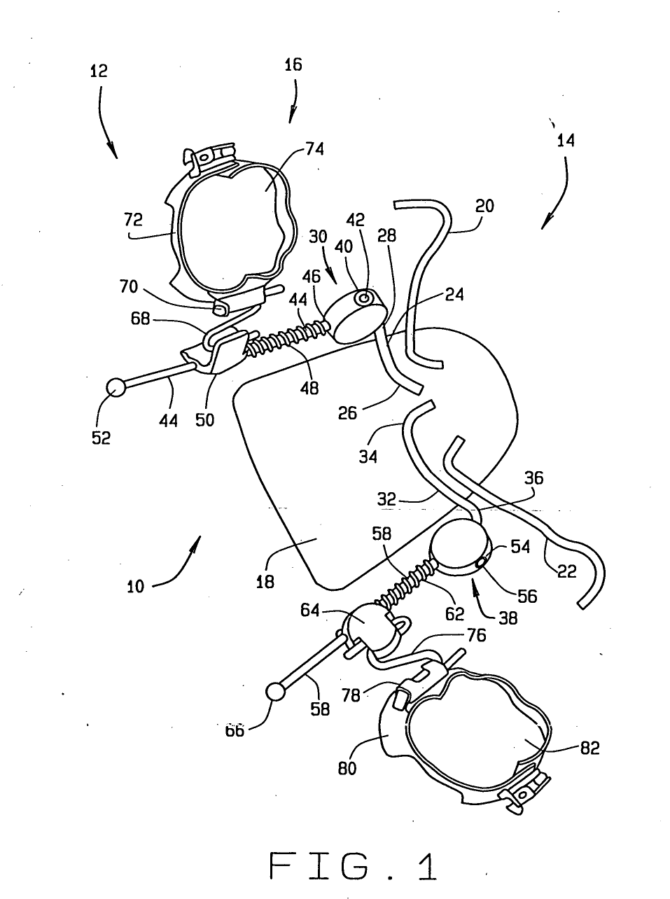

Referring now to the drawings, wherein like numbers refer to like items, number 10 identifies a preferred embodiment of a dental repositioning device constructed according to the present disclosure. With reference now to FIG. 1, the dental repositioning device 10 is shown being inserted into a mouth 12 on teeth 14 of a patient 16. The dental repositioning device comprises a support plate 18 having a first support pin, wire, or rod 20 and a second support pin, wire, or rod 22. The rods 20 and 22 are embedded in the support plate 18. Further, it is possible that a single support rod may be used. The rods 20 and 22 are adapted to fit between teeth 14 to support the device 10 in place in the mouth 12. The support plate 18 may be formed of any suitable material, such as synthetic or natural rubber, medical rubber, plastics such as polyvinyl plastics material including vinyl acetate polymeric material, polyethylene vinyl acetate, or a polyethylene or polypropylene. The material may be clear or colored. The device also comprises a third rod, pin, or wire 24 having a first end 26 that is embedded in the support plate 18 and a second end 28 that is inserted into a first anterior mechanism 30. A fourth rod, pin, or wire 32 has a first end 34 that is also embedded in the support plate 18 and a second end 36 that is inserted into a second anterior mechanism 38. It is also contemplated that the third rod 24 and the fourth rod 32 may be a single rod that is embedded in the support plate 18.

The first anterior mechanism 30 has a top opening 40 that has a set screw 42 inserted therein and a rod 44 inserted into a rear opening 46. The rod 44 has a spring 48 inserted over the rod 44. The spring 48 extends between the first anterior mechanism 30 and a first rear mechanism 50. The rod 44 extends through the first rear mechanism 50 and the rod 44 has a ball end 52. The second anterior mechanism 38 also has a top opening 54 that has a set screw 56 inserted therein and a rod 58 inserted into a rear opening 60. The rod 58 has a spring 62 inserted over the rod 58. The spring 62 extends between the second anterior mechanism 38 and a second rear mechanism 64. The rod 58 extends through the second rear mechanism 64 and the rod 58 has a ball end 66.

A first Z-clip 68 is inserted into the first rear mechanism 50 and a first buccal tube 70. The first buccal tube 70 is mounted on or connected to a first band 72 that has been inserted over or encircles a molar 74. A second Z-clip 76 is inserted into the second rear mechanism 64 and a second buccal tube 78. The second buccal tube 78 is mounted on or connected to a second band 80 that has been placed over a molar 82. Other shaped clips may be used.

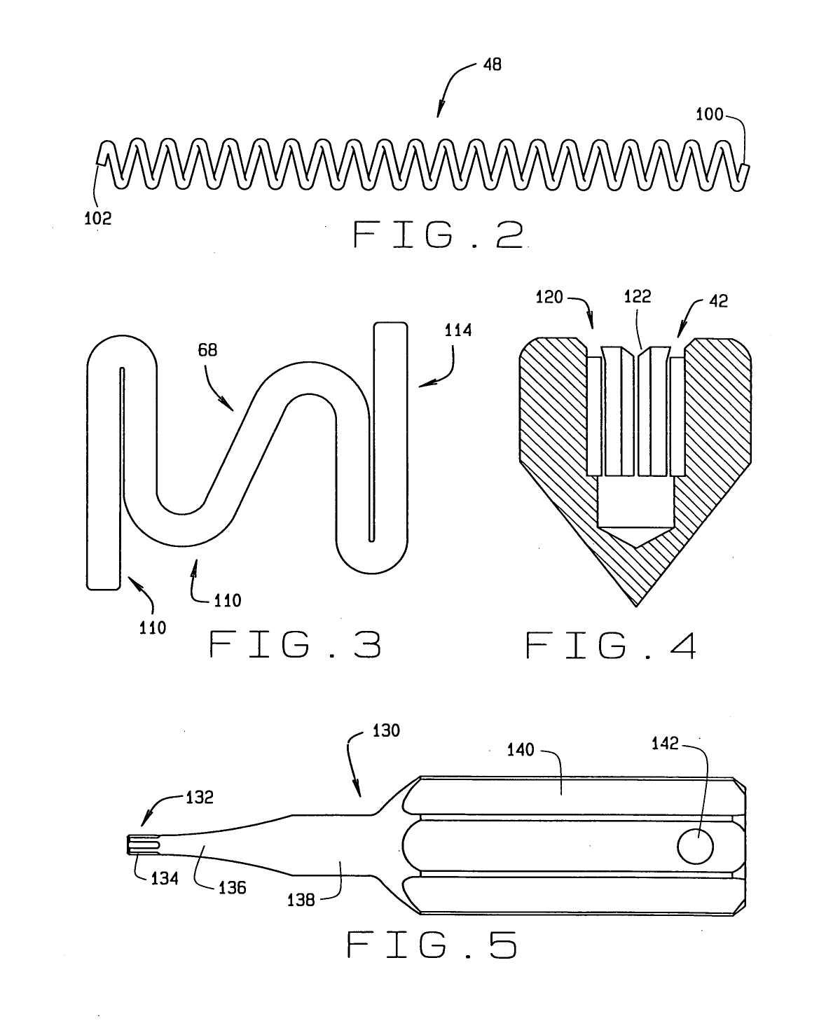

FIG. 2 is a perspective view of the spring 48 removed from the device 10. The spring 48 is a super elastic nickel titanium spring that is capable of maintaining a consistent 200 grams of force. The spring 48 is capable of sliding friction free along the rod 44. The spring 48 has a front or first end 100 that is capable of being captured within the rear opening 46 of the first anterior mechanism 30. The spring 48 also has a rear or second end 102 that is capable of being captured within the first rear mechanism 50. The spring 62 is the same as the spring 48.

Referring now to FIG. 3, a perspective view of the Z-clip 68 is shown. The Z-clip 68 has a first or upper end 110, a central portion 112, and a second or lower end 114. The upper end 110 is adapted to be inserted into the buccal tube 70. The lower end 114 is adapted to be inserted into the first rear mechanism 50. The Z-clip 76 is similar to the Z-clip 68. The clips 68 and 76 may be constructed from any suitable material used for orthodontic appliances such as stainless steel or 303 stainless steel.

FIG. 4 illustrates a perspective view of the set screw 42 that is inserted into the top opening 40 of the first anterior mechanism 30. The set screw 42 is used to lock or secure the rod 44 within the first anterior mechanism 30. The set screw 42 has a top 120 having a slotted opening 122 formed therein. The slotted opening 122 is adapted for receiving a tool (not shown) that may be used to tighten or loosen the set screw 42. The set screw 56 is the same as the set screw 42.

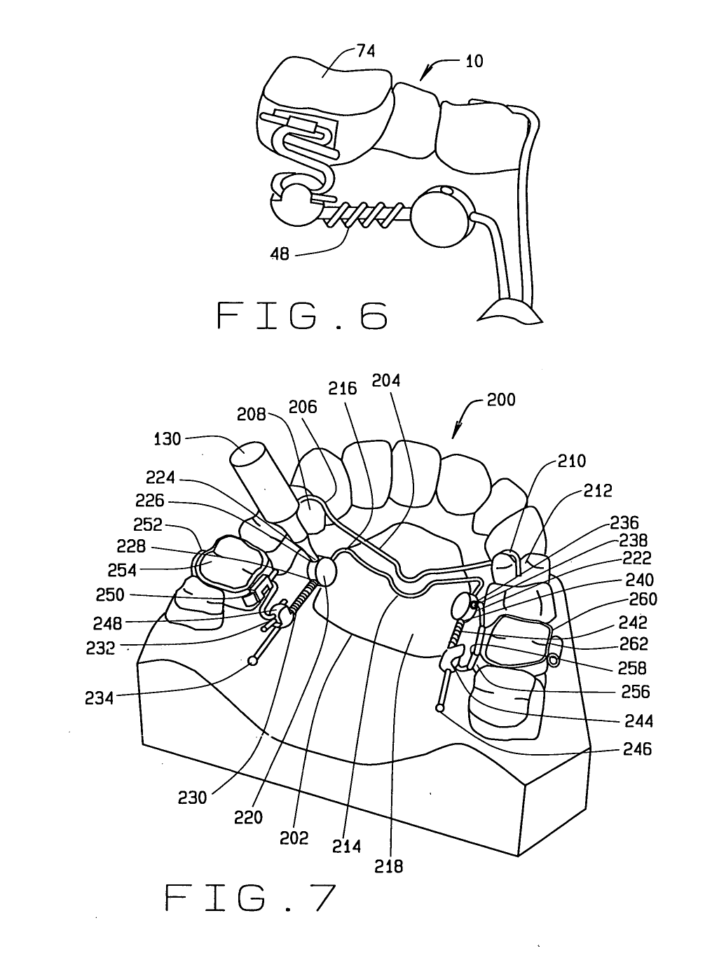

With reference now to FIG. 5, a hand wrench or tool 130 that is used to control operation of or rotate the set screws 42 and 56 is illustrated. The hand wrench 130 has a first or front end 132 that has a complex or fluted head portion 134. The head portion 134 is sized and shaped to fit into the slotted opening 122 of the set screw 42. The complex or fluted shape provides more torque to be applied to the set screw 42 to tighten or loosen the set screw 42. The hand wrench 130 further has a tapered shaft section 136, a straight shaft section 138, and a handle section 140. The handle section 140 has a channel 142 formed therein for attaching a rod (not shown) for providing greater force to loosen or tighten the set screw 42. As can be appreciated, the handle section 140 can be grasped by fingers to twist or rotate the hand wrench 130.

FIG. 6 illustrates the dental repositioning device 10 being used to mesialize the molar 74 by sliding the first anterior mechanism 30 anteriorly and pulling the molar 74 into position. The spring 48 is shown in a loose compression orientation.

With reference now in particular to FIG. 7, another embodiment of a dental repositioning device 200 is shown being adjusted by use of the hand wrench 130. The dental repositioning device 200 is shown comprising a support plate 202 having a first rod 204 embedded therein. The first rod 204 has a first end 206 extending out of the support plate 202 and the first end 206 being secured or mounted on a tooth 208. The first rod 204 also has a second end 210 extending out of the support plate 202 with the second end 210 being secured or mounted to another tooth 212. A second rod 214 is also embedded in the support plate 202. The second rod 214 has a first end 216 and a second end 218 with both of the ends 216 and 218 extending out of the support plate 202. The first end 216 is inserted into a first anterior mechanism 220 and the second end 218 is inserted into a second anterior mechanism 222.

The first anterior mechanism 220 has a top opening 224 that has a set screw 226 inserted therein and the first end 216 of the second rod 214 extends out of a rear opening 228 of the first anterior mechanism 220. The first end 216 has a spring 230 inserted over the first end 216. The spring 230 extends between the first anterior mechanism 220 and a first rear mechanism 232. The first end 216 extends through the first rear mechanism 232 and the first end 216 has a ball end 234. The second anterior mechanism 222 also has a top opening 236 that has a set screw 238 inserted therein and the second end 218 of the second rod 214 extending out of a rear opening 240 of the second anterior mechanism 222. The second end 218 has a spring 242 inserted over the second end 218. The spring 242 extends between the second anterior mechanism 222 and a second rear mechanism 244 The second end 218 extends through the second rear mechanism 244 and the second end 218 has a ball end 246.

A first Z-clip 248 is inserted into the first rear mechanism 232 and a first buccal tube 250. The first buccal tube 250 is mounted on or connected to a first band 252 that has been inserted over or encircles a molar 254. A second Z-clip 256 is inserted into the second rear mechanism 244 and a second buccal tube 258. The second buccal tube 258 is mounted on or connected to a second band 260 that has been placed over another molar 262. As has been previously indicated, the hand wrench 130 is used to tighten or loosen either the set screw 226 or the set screw 238.

During treatment, the dental repositioning device 200⁻may be adjusted accordingly by use of the hand wrench 130 to move the device 200 to reposition teeth, such as the molar 254 or the molar 262. In particular, the hand wrench 130 may be used to rotate the set screws 226 and 238. In this manner, the device 200 can be used to move or reposition the first anterior mechanism 220 and the spring 230 along the first end 216 and the second anterior mechanism 222 and the spring 242 along the second end 218 into a desired position. The set screws 226 and 238 may be used to incrementally reposition the device 200 over time. Over a period of treatment, the device 200 is used to move a tooth or teeth to a correct position in the mouth. Once the treatment has been completed, the device 200 may be removed from the mouth.

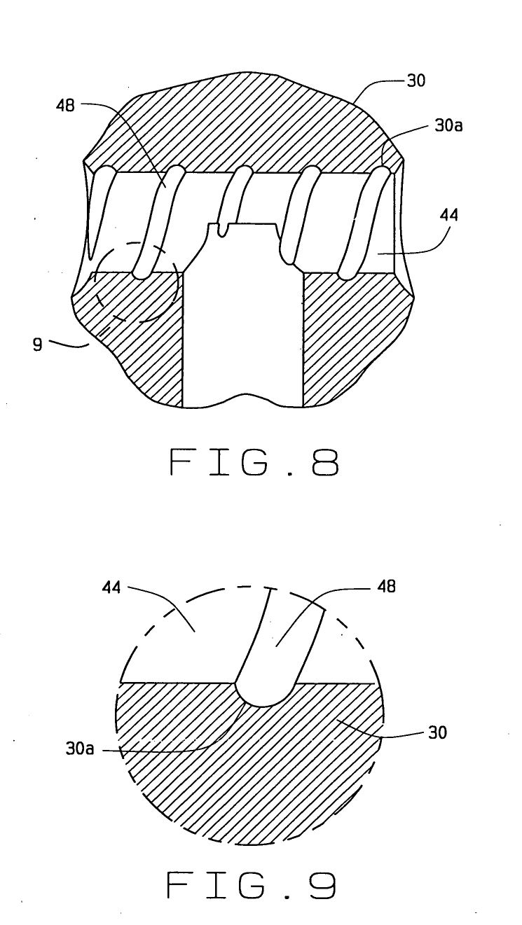

FIG. 8 shows one of the mechanisms, such as the mechanism 30 and discloses how the rod 44 locates therein, and the spring 48 surrounding the rod threadedly engages within the identifies mechanism, as within its formed spiral grooves 30a. FIG. 9 provides an enlarged view, taken along the section 9, of FIG. 8, disclosing in greater detail the grooved inner surface 30a of one of the mechanisms, such as mechanism 30, to affix the spring 48 upon its rod 44 when assembled and adjusted for usage. The set screw may then be fastened to secure the rod and spring in their set location.

From all that has been said, it will be clear that there has thus been shown and described herein a dental repositioning device. It will become apparent to those skilled in the art, however, that many changes, modifications, variations, and other uses and applications of the subject dental repositioning device are possible and contemplated. All changes, modifications, variations, and other uses and applications which do not depart from the spirit and scope of the disclosure are deemed to be covered by the disclosure, which is limited only by the claims which follow.

What is claimed is:

1. A dental repositioning device comprising:
a support plate having a first rod embedded therein and a second rod embedded therein;
a first anterior mechanism having a top opening for receiving a set screw and a rear opening;
a second anterior mechanism having a top opening for receiving a set screw and a rear opening;
a first rod connected between the first anterior mechanism and a first rear mechanism and a spring inserted over the first rod between the first anterior mechanism and the first rear mechanism;
a second rod connected between the second anterior mechanism and a second rear mechanism and a spring inserted over the second rod between the second anterior mechanism and the second rear mechanism;
a first Z-clip for insertion into the first rear mechanism and a first buccal tube; and
a second Z-clip for insertion into the second rear mechanism and a second buccal tube.

2. The dental repositioning device of claim 1 wherein the first rod has a ball end.

3. The dental repositioning device of claim 1 wherein the second rod has a ball end.

4. The dental repositioning device of claim 1 wherein the first spring is a super elastic nickel titanium spring.

5. The dental repositioning device of claim 1 wherein the second spring is a super elastic nickel titanium spring.

6. The dental repositioning device of claim 1 wherein the first anterior mechanism is connected to the first rod embedded in the support plate.

7. The dental repositioning device of claim 1 wherein the second anterior mechanism is connected to the second rod embedded in the support plate.

8. A dental repositioning device comprising:
a support plate having a rod embedded therein with the rod having a pair of ends extending out of the support plate;
a first anterior mechanism having a top opening for receiving a set screw, a front opening for receiving one of the pair of rod ends extending out of the support plate, and a rear opening;
a second anterior mechanism having a top opening for receiving a set screw, a front opening for receiving the other one of the pair of rod ends extending out of the support plate, and a rear opening;
a first rod inserted into the rear opening of the first anterior mechanism and extending between the first anterior mechanism and a first rear mechanism and a spring inserted over the first rod between the first anterior mechanism and the first rear mechanism;
a second rod inserted into the rear opening of the second anterior mechanism and extending between the second anterior mechanism and a second rear mechanism and a spring inserted over the second rod between the second anterior mechanism and the second rear mechanism;
a first Z-clip for insertion into the first rear mechanism and a first buccal tube; and
a second Z-clip for insertion into the second rear mechanism and a second buccal tube.

9. The dental repositioning device of claim 8 wherein the first rod has a ball end.

10. The dental repositioning device of claim 8 wherein the second rod has a ball end.

11. The dental repositioning device of claim 8 wherein the first spring is a super elastic nickel titanium spring.

12. The dental repositioning device of claim 8 wherein the second spring is a super elastic nickel titanium spring.

13. The dental repositioning device of claim 8 wherein the first buccal tube is connected to a band that encircles a molar.

14. The dental repositioning device of claim 8 wherein the second buccal tube is connected to a band that encircles a molar.

15. A dental repositioning device comprising:
a support plate having a first rod embedded therein and extending out of the support plate adapted for placement on a tooth and a second rod embedded therein and extending out of the support plate adapted for placement on another tooth;
a first anterior mechanism having a top opening for receiving a set screw and a rear opening;
a second anterior mechanism having a top opening for receiving a set screw and a rear opening;
a first rod embedded in the support plate and extending between the first anterior mechanism and a first rear mechanism and a⁻spring inserted over the first rod between the first anterior mechanism and the first rear mechanism;
a second rod embedded in the support plate and between the second anterior mechanism and a second rear mechanism and a spring inserted over the second rod between the second anterior mechanism and the second rear mechanism;
a first Z-clip for insertion into the first rear mechanism and a first buccal tube; and
a second Z-clip for insertion into the second rear mechanism and a second buccal tube.

16. The dental repositioning device of claim 15 wherein the first rod has a ball end.

17. The dental repositioning device of claim 15 wherein the second rod has a ball end.

18. The dental repositioning device of claim 15 wherein the first spring is a super elastic nickel titanium spring.

19. The dental repositioning device of claim 15 wherein the second spring is a super elastic nickel titanium spring.

20. The dental repositioning device of claim 15 further comprising a hand wrench for rotating the set screw.
